(19) United States
(12) Patent Application Publication
(10) Pub. No.: US 2010/0191550 A1
(43) Pub. Date: Jul. 29, 2010

(54) SYSTEMS AND METHODS OF HANDLING TRAVEL PRODUCTS ONLINE

(76) Inventor: Lawrence Hutson, Sarasota, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/445,985

(22) PCT Filed: Oct. 19, 2007
(86) PCT No.: PCT/US07/81995

§ 371 Date: Mar. 31, 2010

Related U.S. Application Data
(60) Provisional application No. 60/853,367, filed on Oct. 20, 2006.
(60) Provisional application No. 60/853,370, filed on Oct. 20, 2006.
(60) Provisional application No. 60/853,372, filed on Oct. 20, 2006.
(60) Provisional application No. 60/853,368, filed on Oct. 20, 2006.
(60) Provisional application No. 60/853,189, filed on Oct. 20, 2006.

(51) Int. Cl. G06Q 50/00; G06F 17/30; G06Q 30/00; G06Q 20/00

(52) U.S. Cl. 705/5; 707/711; 707/770; 705/27

(57) ABSTRACT

Systems and methods for searching and distributing online travel products are disclosed. One such method, performed by a travel distributor, includes receiving a search request from a customer describing a travel product of interest to the customer. The method further includes submitting the search request to each of a plurality of travel product providers. Each of the travel product providers have an agreement specifying a revenue split for each travel product offered by the provider to the distributor. The method further includes receiving a search result. The received search result includes at least a portion of the plurality of travel products as a result of the search request. The method further includes selecting one of products in the search result as a best choice for the customer, and selling the selected travel product online to the customer.

### TECHNICAL FIELD

The present disclosure relates to selling travel products online.

### BACKGROUND

Consumers often use search engines when buying products online. However, conventional search engines (e.g., Google, Yahoo, etc.) are not very useful when searching for travel products. Conventional, general-purpose search engines work by periodically “crawling” the Internet to find content, and building indexes to the content. This approach does not work well for travel products, since much of the data associated with a travel product is volatile. This is especially true of price and availability—the availability of products like flights, rooms, and rentals changes from minute to minute. Therefore, conventional search engines cannot account for the availability of a travel product when providing search results.

Consumers therefore turn to conventional travel websites such as Travelocity, Expedia, or Orbitz. Consumers can find a travel product and purchase it through a conventional website. These conventional travel websites, or booking engines, rely on a centralized reservation system, typically the Global Distribution System (GDS), to make a reservation for the purchased product. Travel product providers such as airlines, hotels, etc., periodically push their product description, pricing and availability data into the GDS. All reservations for these products come through the GDS, allowing the GDS to maintain real-time inventory and associated fares.

A conventional travel website is essentially a front-end to a GDS, which has several potential implications for consumers. One, the product data in the GDS is defined by a specific destination and a date: a flight from Atlanta to New York on May 30, 2006; a hotel room in Paris, France for Jul. 1 to Jul. 4, 2006. A conventional travel website may offer some degree of higher level searches (search “flights on May 30, 2006 from Atlanta to Newark, La Guardia, or Kennedy airports”) by implementing a layer on top of GDS. However, a conventional travel website cannot offer searches like “skiing in Utah” or “fishing in Costa Rica” because the underlying GDS data is not structured this way. Two, the operator of the conventional travel website is essentially in the business of providing data, not in the travel business. Because the GDS is the only way to access the data, conventional travel websites must adhere to the pricing structure used by the GDS, where the product provider pays the GDS a transaction fee for each reservation. Therefore, consumers pay retail rates for travel products.

A conventional travel website using GDS typically offers access to traditional travel products provided by large operators, such as airline flights, hotel rooms, rental cars. A wide variety of travel products are sold by small product and regional specialists who are located at the destination. Since they are located at the destination, there are known as “inbound operators”, as distinguished from operators located at the departure location, which are known as “outbound operators”. Examples of products offered by inbound operators are excursions, boat charters, sporting events, attractions, airport transfers, guided tours, restaurants, and diving. Today, these inbound operator products are manually distributed by outbound tour operators, using a multi-step, paper-intensive process, which involves the inbound operator, the outbound operator, and local travel agencies. The inbound operator products are not typically available for purchase online, since the cost to a small operator of supplying data to the GDS is prohibitive.

### SUMMARY

Systems and methods distributing travel products online are disclosed. A first method is performed by an online travel distributor, and includes the steps of negotiating agreements for at least one travel product with each of a plurality of providers, and receiving a product description from a customer describing a travel product of interest to the customer. Each agreement specifies a revenue split for each travel product offered by the provider. The first method further includes determining a matching subset of the travel products offered by the plurality of providers based on the product description, selecting one of the matching travel products as a best choice for the customer, and selling the selected travel product online to the customer. The first method may further include: collecting payment for the sale from the customer, and distributing the payment according to the revenue split in the product agreement. The first method may further include collecting payment for the sale from the customer in a first currency associated with the customer; and distributing the payment in a second currency associated with the provider according to the revenue split in the product agreement. The distributing may further include: allocating a portion of the profit to the payment to the online travel distributor according to the revenue split in the product agreement, and paying the product provider according to the revenue split in the product agreement. The selling may further include making a reservation for the selected travel product.

The first method may further include: creating a search request based on the product description received from the customer; submitting the search request to each of the plurality of providers; receiving a subset of the plurality of travel products as a result of the search request; and selecting one of products in the subset as the best choice for the customer. The first method may further include: creating a search request based on the product description received from the customer; mapping the search request to a plurality of search requests, each of the mapped search requests in a format understood by one of the plurality of providers; submitting each of the mapped search requests to the corresponding provider; receiving a result including at least a portion of the plurality of travel products in response to the mapped search requests; and mapping the products in the result to a common format; selecting one of products in the result as the best choice for the customer.

The first method may further include: creating a list of master products which include the product destination and a list of providers offering each master product, to produce a product matrix; for each provider in the list, mapping the search request to a provider-specific search request using a format understood by that provider; submitting, to each of provider in the list, the mapped search request for that provider.

The first method may further include: determining whether one provider product in the result represents the same master product as another provider product in the results set; and responsive to the determination, removing from the matrix one of the provider products representing the same master product. The removing may further include: selecting from the matrix one of the provider products representing the same master product, based on pricing rules associated with each provider product; and removing the selected provider product from the matrix.

The first method may further include: storing a plurality of provider products from a first provider in a first VendorProducts database table; storing a plurality of provider products from a second provider in a second VendorProducts database table; creating a masterProducts database table to produce a unique set of products from the first and second VendorProducts database table; and for each product in the first and second VendorProducts database table, setting a link from that provider product to a corresponding product in the masterProducts table to capture the relationship between that provider product and that corresponding master product as representing the same product. The first method may further include: removing from the matrix any product which is not included in the result; and removing from the matrix any product corresponding to a request which was not answered.

The first method may further include: for each product in the result, filling in the products in the matrix with price information from the search results; applying a pricing rule associated with each product in the matrix to the price information of that product to produce a final price for that product; and selecting one or more of the products in the matrix as the best choice for the customer based on the final price of each product. The pricing rule may specify cost-plus or price-minus. The pricing rule may apply to a net product or a commissionable product. The pricing rule may apply to a cost range for the product. The travel product includes air, hotel, or car rental. The travel product may include a dynamic package or a pre-defined package.

Each provider may be associated with a preferred currency, and the payment to the provider is made using the preferred currency, each provider is associated with at least one payment option, and the payment collected from the user may be limited to the associated payment option. The first method may further include: making a reservation each product in the bundle of travel products separately. The order of reservations is based on a cancellation policy associated with each product in the bundle. The travel product may include an air product and an additional product. The first method may further include making a reservation for the air product before the reservation for the additional product.

A second method is performed by a travel distributor, and includes: receiving a search request from a customer describing a travel product of interest to the customer; and submitting the search request to each of a plurality of travel product providers. Each of the travel product providers having an agreement specifying a revenue split for each travel product offered by the provider to the distributor. The second method further includes: receiving a search result including at least a portion of the plurality of travel products as a result of the search request; selecting one of products in the search result as a best choice for the customer; and selling the selected travel product online to the customer. The selling may further include: making a reservation for the selected travel product on behalf of the customer; collecting payment for the sale from the customer; and distributing the payment according to the revenue split in the product agreement.

The second method may further include: creating a search request based on the product description received from the customer; and mapping the search request to a plurality of search requests. Each of the mapped search requests is in a format understood by one of the plurality of providers. The second method may further include: submitting each of the mapped search requests to the corresponding provider; receiving a result of the plurality of travel products in response to the mapped search requests; mapping each product in the result to a common format; selecting one of products in the result as the best choice for the customer.

The second method may further include: creating a list of master products which include the destination and a list of providers offering each master product, to produce a product matrix; for each provider in the list, mapping the search request to a provider-specific search request using a format understood by that provider; and submitting, to each of provider in the list, the mapped search request for that provider.

The second method may further include: determining whether one provider product in the result represents the same master product as another provider product in the results set; and responsive to the determination, removing from the matrix one of the provider products representing the same master product. The removing may further include: selecting from the matrix one of the provider products representing the same master product, based on pricing rules associated with each provider product; and removing the selected provider product from the matrix.

The second method may further include: storing a plurality of provider products from a first provider in a first VendorProducts database table; storing a plurality of provider products from a second provider in a second VendorProducts database table; creating a masterProducts database table to produce a unique set of products from the first and second VendorProducts database table; and for each product in the first and second VendorProducts database table, setting a link from that provider product to a corresponding product in the masterProducts table to capture the relationship between that provider product and that corresponding master product as representing the same product. The second method may further include: removing from the matrix any product which is not included in the result; and removing from the matrix any product corresponding to a request which was not answered.

The second method may further include: for each product in the result, filling in the products in the matrix with price information from the search results; applying a pricing rule associated with each product in the matrix to the price information of that product to produce a final price for that product; and selecting one or more of the products in the matrix as the best choice for the customer based on the final price of each product. The pricing rule may specify cost-plus or price-minus. The pricing rule may apply to a net product or a commissionable product. The pricing rule may apply to a cost range for the product. The travel product may include air, hotel, or car rental. The travel product may include a dynamic package or a pre-defined package. Each provider may be associated with a preferred currency, and the payment to the provider may be made using the preferred currency. Each provider may be associated with at least one payment option, and the payment collected from the user may be limited to the associated payment option.

The second method may further include: making a reservation each product in the bundle separatel. The order of reservations may be based on a cancellation policy associated with each product in the bundle. The second method may further include: making a reservation for the air product before the reservation for the additional product.

A third method includes receiving a first consumer travel search request at a first website operated by a distributor. The first consumer travel search request includes a first travel product description. The third method further includes: producing a first web page including a first set of search results in response to the first consumer travel search request; and receiving a second consumer travel search request at the first website. The second consumer travel search request includes a second travel product description which may be substantially equivalent to the first travel product description. The second consumer travel search request is received after redirection from a second website operated by a distribution partner of the distributor. The third method further includes sending to the second website a second web page including substantially a second set of search results which may be substantially the same as the first set of search results.

The second webpage may have a visual appearance susbantially identical to a webpage on the second website. The redirection may be transparent to a consumer using the second website. The redirection may be effected by the first website in a manner which may be transparent to a consumer using the second website. The redirection may be a result of user selection of a hyperlink on the second website.

The third method may further include: performing search engine optimization on a plurality of web pages on the first website in order to positively affect a search by a search engine for keywords on the plurality of web pages. The method may further include: performing search engine optimization on a plurality of web pages on the first website in order to positively affect a search by a search engine for keywords on the plurality of web pages; and receiving, by a search engine website, a third consumer travel search request; searching, by the search engine website, an index of web pages including the optimized pages on the first website; and returning, by the search engine webstite, one of the optimized pages as a result of the third consumer travel search request.

A fourth method is performed by a travel product distributor, and includes: allowing each of a plurality of inbound travel operators to upload a description of a travel product offered by that travel operator, the description specifying a revenue split for the travel product; offering for online sale to consumers the plurality of travel products; and selling one of the plurality of travel products as selected by a consumer. The fourth method may further include: collecting payment for the sale from the customer; and distributing the payment according to the revenue split associated with the product. The service may be provided at no charge to the travel operator. The selling may further include: making a reservation for the selected travel product.

The fourth method may further include: providing a booking service to the operator through which the operator can make reservations for the travel products offered by the operator and sold online by the distributor. The fourth method may further include: providing a service to the operator through which the operator can view new bookings made by the distributor for the travel products offered by the operator. The fourth method may further include: providing a service to the operator through which the operator can view new cancellations of bookings made by the distributor for the travel products offered by the operator.

The fourth method may further include: providing a service to the operator through which the operator can view arrival lists corresponding to bookings made by the distributor for the travel products offered by the operator. The fourth method may further include: allocating a portion of the profit to the payment to the online travel distributor according to the revenue split associated with the product; and paying the provider of the product according to the revenue split associated with the product.

The travel products may include ground transportation, an activity confined to a single day, and a tour covering multiple destinations. The description of each travel product may include at least one operating time, and a price and allocation for each operating time. The description of each travel product may include at least one operating time, and a price and allocation for each operating time, wherein the price is described as net of a specified commission or subject to the commission. The description of each travel product may include at least one operating time, and a price and allocation for each operating time, wherein the price is specified as per-person, per-night, per-hour, per-day, or per-group, the description of each travel product may include a duration, a list of days, and a description of each day. The description of each travel product may include a description of meals provided, the description of each travel product may include a list of included services. The description of each travel product may include a default currency in which the operator will be paid.one of the travel products is an activity, and the product description may include a language associated with the activity.

A first computer-implemented first computer-implemented method includes: receiving a search request from a customer describing a travel product of interest to the customer; submitting the search request to each of a plurality of travel product providers, each of the travel product providers having an agreement specifying a revenue split for each travel product offered by the provider to the distributor; receiving a search result including at least a portion of the plurality of travel products as a result of the search request; selecting one of products in the search result as a best choice for the customer; and selling the selected travel product online to the customer. The selling may further include: making a reservation for the selected travel product on behalf of the customer; collecting payment for the sale from the customer; and distributing the payment according to the revenue split in the product agreement.

The first computer-implemented method may further include: creating a search request based on the product description received from the customer; mapping the search request to a plurality of search requests, each of the mapped search requests in a format understood by one of the plurality of providers; submitting each of the mapped search requests to the corresponding provider; receiving a result of the plurality of travel products in response to the mapped search requests; mapping each the products in the result to a common format; and selecting one of products in the result as the best choice for the customer.

The first computer-implemented method may further include: creating a list of master products which include the destination and a list of providers offering each master product, to produce a product matrix; for each provider in the list, mapping the search request to a provider-specific search request using a format understood by that provider; and submitting, to each of provider in the list, the mapped search request for that provider.

The first computer-implemented method may further include: determining whether one provider product in the result represents the same master product as another provider product in the results set; and responsive to the determination, removing from the matrix one of the provider products representing the same master product. The removing further includes: selecting from the matrix one of the provider products representing the same master product, based on pricing rules associated with each provider product; and removing the selected provider product from the matrix.

The first computer-implemented method may further include: storing a plurality of provider products from a first provider in a first VendorProducts database table; storing a plurality of provider products from a second provider in a second VendorProducts database table; creating a masterProducts database table to produce a unique set of products from the first and second VendorProducts database table; and for each product in the first and second VendorProducts database table, setting a link from that provider product to a corresponding product in the masterProducts table to capture the relationship between that provider product and that corresponding master product as representing the same product.

The first computer-implemented method may further include: removing from the matrix any product which is not included in the result; and removing from the matrix any product corresponding to a request which was not answered. The first computer-implemented method may further include: for each product in the result, filling in the products in the matrix with price information from the search results; applying a pricing rule associated with each product in the matrix to the price information of that product to produce a final price for that product; and selecting one or more of the products in the matrix as the best choice for the customer based on the final price of each product. The pricing rule may specify cost-plus or price-minus. The pricing rule may apply to a net product or a commissionable product. The pricing rule may apply to a cost range for the product. The travel product may include air, hotel, or car rental. The travel product may include a dynamic package or a pre-defined package. Each provider may be associated with a preferred currency, and the payment to the provider may be made using the preferred currency. Each provider may be associated with at least one payment option, and the payment may be collected from the user is limited to the associated payment option.

The first computer-implemented method may further include: making a reservation each product in the bundle separately. The order of reservations is based on a cancellation policy associated with each product in the bundle. The first computer-implemented method may further include: making a reservation for the air product before the reservation for the additional product.

A second computer-implemented method includes: receiving a first consumer travel search request at a first website operated by a distributor, the first consumer travel search request including a first travel product description; producing a first web page including a first set of search results in response to the first consumer travel search request; and receiving a second consumer travel search request at the first website. The second consumer travel search request includes a second travel product description which is substantially equivalent to the first travel product description. The second consumer travel search request is received after redirection from a second website operated by a distribution partner of the distributor. The second computer-implemented second computer-implemented method further includes: sending to the second website a second web page including substantially a second set of search results which is substantially the same as the first set of search results.

The second webpage may have a visual appearance which is substantially identical to a webpage on the second website. The redirection may be transparent to a consumer using the second website. The redirection may be effected by the first website in a manner which is transparent to a consumer using the second website. The redirection may be a result of user selection of a hyperlink on the second website.

The second computer-implemented method may further include: performing search engine optimization on a plurality of web pages on the first website in order to positively affect a search by a search engine for keywords on the plurality of web pages. The second computer-implemented method may further include: performing search engine optimization on a plurality of web pages on the first website in order to positively affect a search by a search engine for keywords on the plurality of web pages; and receiving, by a search engine website, a third consumer travel search request; searching, by the search engine website, an index of web pages including the optimized pages on the first website; and returning, by the search engine website, one of the optimized pages as a result of the third consumer travel search request.

A first system includes memory have stored thereon program code, and a processor that is programmed by at least the program code to enable the system to: receive a search request from a customer describe a travel product of interest to the customer; submit the search request to each of a plurality of travel product providers. Each of the travel product providers have an agreement specify a revenue split for each travel product offered by the provider to the distributor. The first system is further programmed to enable the system to: receive a search result include at least a portion of the plurality of travel products as a result of the search request; select one of products in the search result as a best choice for the customer; and sell the selected travel product online to the customer.

The processor is further programmed to enable the system to: make a reservation for the selected travel product on behalf of the customer; collected payment for the sale from the customer; and distribute the payment according to the revenue split in the product agreement, the processor is further programmed to enable the system to: create a search request based on the product description received from the customer; map the search request to a plurality of search requests, each of the mapped search requests in a format understood by one of the plurality of providers; submit each of the mapped search requests to the corresponding provider; receive a result of the plurality of travel products in response to the mapped search requests; map each the products in the result to a common format; and select one of products in the result as the best choice for the customer.

The processor is further programmed to enable the system to: create a list of master products which include the destination and a list of providers offering each master product, to produce a product matrix; for each provider in the list, map the search request to a provider-specific search request use a format understood by that provider; submit, to each of provider in the list, the mapped search request for that provider.

The processor is further programmed to enable the system to: determine whether one provider product in the result represents the same master product as another provider product in the results set; and responsive to the determination, remove from the matrix one of the provider products representing the same master product. The processor is further programmed to enable the system to: select from the matrix one of the provider products represente the same master product, based on price rules associated with each provider product; and remove the selected provider product from the matrix.

The processor is further programmed to enable the system to: store a plurality of provider products from a first provider in a first VendorProducts database table; store a plurality of provider products from a second provider in a second VendorProducts database table; create a masterProducts database table to produce a unique set of products from the first and second VendorProducts database table; and for each product in the first and second VendorProducts database table, set a link from that provider product to a corresponde product in the masterProducts table to capture the relationship between that provider product and that corresponde master product as represente the same product. The processor is further programmed to enable the system to: remove from the matrix any product which is not included in the result; and remove from the matrix any product corresponde to a request which was not answered.

The processor is further programmed to enable the system to: for each product in the result, fill in the products in the matrix with price information from the search results; apply a price rule associated with each product in the matrix to the price information of that product to produce a final price for that product; and select one or more of the products in the matrix as the best choice for the customer based on the final price of each product. The price rule may specify cost-plus or price-minus. The price rule may apply to a net product or a commissionable product. The price rule may apply to a cost range for the product. The travel product may include air, hotel, or car rental. The travel product may include a dynamic package or a pre-defined package. Each provider may be associated with a preferred currency, and the payment to the provider may be made use the preferred currency. Each provider may be associated with at least one payment option, and the payment collected from the user may be limited to the associated payment option.

The processor is further programmed to enable the system to make a reservation each product in the bundle separately. The order of reservations is based on a cancellation policy associated with each product in the bundle. The processor is further programmed to enable the system to: make a reservation for the air product before the reservation for the additional product.

A second computer-implemented includes memory having stored thereon program code, and a processor that is programmed by at least the program code to enable the system to: receive a first consumer travel search request at a first website operated by a distributor, the first consumer travel search request including a first travel product description; produce a first web page including a first set of search results in response to the first consumer travel search request; receive a second consumer travel search request at the first website. The second consumer travel search request including a second travel product description which is substantially equivalent to the first travel product description. The second consumer travel search request being received after redirection from a second website operated by a distribution partner of the distributor.

The processor is further programmed to enable the system to: send to the second website a second web page including substantially a second set of search results which is substantially the same as the first set of search results. The second webpage may have a visual appearance which is substantially identical to a webpage on the second website. The redirection may be transparent to a consumer using the second website. The redirection may be effected by the first website in a manner which is transparent to a consumer using the second website. The redirection may be a result of user selection of a hyperlink on the second website.

The processor is further programmed to enable the system to: perform search engine optimization on a plurality of web pages on the first website in order to positively affect a search by a search engine for keywords on the plurality of web pages, the processor is further programmed to enable the system to: perform search engine optimization on a plurality of web pages on the first website in order to positively affect a search by a search engine for keywords on the plurality of web pages, so that a search engine website receiving a third consumer travel search request responds by searching an index of web pages including the optimized pages on the first website and returning one of the optimized pages as a result of the third consumer travel search request.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of an online travel distribution system, according to some embodiments of the present invention.

FIG. 2 is a block diagram of another embodiment of the online travel distribution system from FIG. 1

FIG. 3 is a block diagram of selected components of the online travel distributor server from FIG. 1.

FIG. 4. is a messaging diagram for a travel product searching or shopping process performed by the online travel distributor server from FIG. 1.

FIG. 5 is a block diagram illustrating the matching process from FIG. 4.

FIG. 6 is a block diagram illustrating the price and availability query process from FIG. 4.

FIG. 7 is a block diagram illustrating the merge process from FIG. 4.

FIG. 8 illustrates an example schema for the cross-reference database from FIG. 3.

FIG. 9 is a sequence diagram illustrating operation of an example embodiment of the reservation middleware from FIG. 3.

FIG. 10 is a flow chart illustrating operation of an example embodiment of the destination middleware from FIG. 3.

FIG. 11 illustrates an example schema for the user settings database from FIG. 3.

FIG. 12 is a flowchart illustrating a process used by one embodiment of the online travel distributor server from FIG. 3 to distribute inbound operator products.

FIG. 13 is a flow chart illustrating a process used by one embodiment of the online travel distributor server from FIG. 3 to track payments distributed among travel affiliates.

FIG. 14 is a block diagram of a network environment for the online travel distribution system from FIG. 1.

FIG. 15 is a hardware block diagram of a general-purpose computer which can be used to implement various embodiments of the online travel distributor server from FIG. 1.

### DETAILED DESCRIPTION

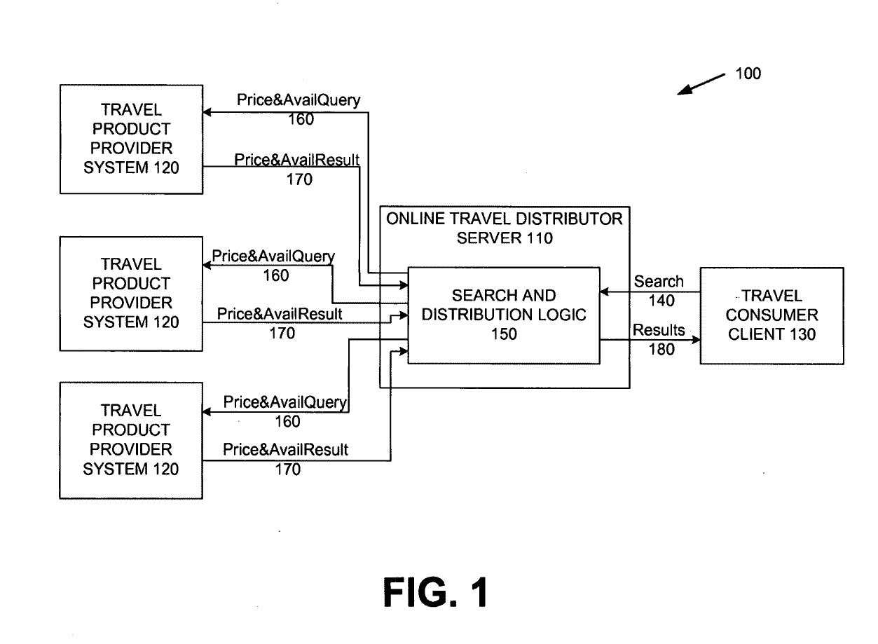

FIG. 1 is a block diagram of an online travel distribution system 100, according to some embodiments of the present invention. Online travel distribution system 100 includes an online travel distributor server 110, one or more travel product provider systems 120, and one or more travel consumer clients 130, which are in communication via a network (not shown). Online travel distributor server 110 is a computer system operated by a distributor of travel products, while each travel product provider system 120 is operated by a provider of travel products. The travel products distributor negotiates agreements for the products with the travel product providers. The agreements specify which products can be distributed, and a revenue split for each. The travel products can include those products available through the GDS, as well as products not available through the GDS.

The distributor allows consumers to search for and/or purchase travel products online from any of the travel product providers, using travel consumer client 130. The distributor collects payment from the consumer, takes a profit from the sale and pays the provider, both according to the agreed-on revenue split policy. This model obtains better prices for the consumer than the conventional travel website model. Product prices are negotiated wholesale rates rather than retail rates as with GDS. Also, access to multiple travel product providers allows the distributor to query each travel product provider for its wholesale rate for a particular product, and present to the consumer the product with the best price.

Travel consumer client 130 submits a search request 140 to online travel distributor server 110. Search and distribution logic 150 at online travel distributor server 110 receives search request 140 and identifies travel product(s) which match search request 140. For each matching travel product, online travel distributor server 110 creates multiple price and availability queries 160 corresponding to the travel product, where each price and availability query 160 is provider-specific. For example, consider a user search request for “best rate for four-star European hotel”. Providers may use different definitions for “Europe”, different definitions for “four star”, different codes for hotels, and different codes for classes of rooms. Online travel distributor server 110 uses provider-specific information to construct appropriate queries for different providers.

Various travel product provider systems 120 return a price and availability result 170 for the queried travel product. Each price and availability result 170 is also provider-specific, so online travel distributor server 110 converts the different types of results 170 back into a common format. Converting the query results 170 into a common format allows online travel distributor server 110 to perform an “apples to apples” comparison, knowing that the “European four-star hotel” product offered by one distributor is the same, or equivalent to, the product offered by another distributor. The criteria for comparison is typically price, although other criteria may be considered also. Online travel distributor server 110 further provides travel consumer client 130 with search results 180, which include a ranked list of travel products which match search request 140. In some embodiments, extensible markup language (XML) is used for the common format.

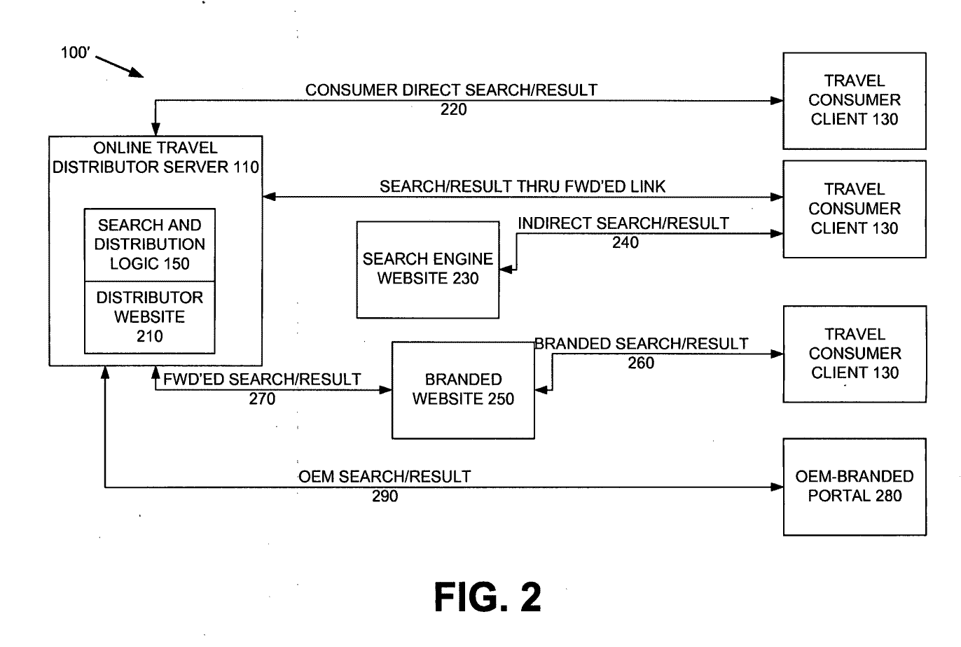

FIG. 2 is a block diagram of another embodiment of online travel distributor server 110 of FIG. 1. Online travel distribution system 100′ includes an online travel distributor server 110′ and one or more travel consumer clients 130. Search and distribution logic 150 at online travel distributor server 110′ provides consumers with access to travel products of the online travel distributor through several different points of entry, described below. A particular embodiment of online travel distribution system 100′ may include any combination of two of these points of entry.

One point of entry allows a consumer to access the distributor's services directly, by submitting a travel product search request directly to a distributor website 210 that is hosted by the online travel distributor. Search and distribution logic 150 handles the consumer-direct search request for a travel product in the manner described earlier in connection with FIG. 1, producing a result which is provided to travel consumer client 130 through distributor website 210. (To simplify the diagram, a single arrow 220 is used in FIG. 2 to represent the consumer-direct search request and the corresponding result.) Although distributor website 210 and search and distribution logic 150 reside at the same server in FIG. 2, in another embodiment these components are located in different servers, or remote from online travel distributor server 110′.

Distributor website 210 is operated by the online travel distributor and uses the distributor's brand. This consumer-direct website includes searchable travel product content and a booking engine through which the consumer can purchase travel products. However, other mechanisms for accessing online travel distributor server 110′ may be useful, since promoting a brand to attract customers can be expensive.

For this reason, some embodiments of distributor website 210 are also optimized for search engines. This provides a second point of entry, through which consumers find distributor products indirectly, through a conventional search engine website 230 (e.g., Google, Yahoo, etc.). Search engine website 230 receives a consumer travel search request, performs a conventional search, and provides results. (To simplify the diagram, a single arrow 240 represents the search engine request and the corresponding result.) In some embodiments, search result 240 includes a uniform resource locator (URL) which directly references distributor website 210. In some embodiments, search result 240 includes a URL that references another content website (e.g. “skiing-in-the-alps.com” or “fishing-in-costa-rica.com”). This other content website houses the same product content found on distributor website 210, and also connects to search and distribution logic 150. In either case, search and distribution logic 150 handles the consumer-generated search request in the manner described earlier in connection with FIG. 1, producing a result which is provided to travel consumer client 130 through distributor website 210.

The online travel distributor may make alliances with distribution partners, allowing the distribution partners to sell the travel products offered by the online distributor and to split the revenue. This provides yet another point of entry for distributor's products: a “private label” branded travel website 250, operated by distribution partner. As a hypothetical example, “Carz” magazine may operate the branded website “carz.com”. Branded website 250 includes a hyperlink which leads the user to a travel search engine. The travel search engine provided by branded website 250 typically offers the usual variety of travel products, but may also feature specials on products that are somehow related to the distribution partner's brand. For example, the hypothetical travel search engine as accessed through “carz.com” may offer specials on car-related travel, such as packages to the Indy 500, driving tours of Bavaria, performance driving schools, etc.

The travel search process operates as follows. The user submits a travel search request to branded website 250, which is forwarded or redirected to distributor website 210. Search and distribution logic 150 handles the forwarded search request in the manner described earlier in connection with FIG. 1, producing a result which is provided back to travel consumer client 130. (To simplify the diagram, a single arrow 260 represents the consumer request and the corresponding result, and a single arrow 270 represents the forwarded request and the corresponding result.)

Although the branded travel search engine appears to be part of branded website 250, it is instead hosted by distributor website 210. The connection to distributor website 210 is transparent to the consumer. That is, the distributor's web server is serving the web pages, but the consumer sees only the private label branded website 250 of the distribution partner. This differs from linking to travel websites as is conventionally done, where the user leaves the private label website and enters the conventional travel website (e.g., Travelocity®, Expedia®, Orbitz®, etc.) The conventional approach provides no incentive for the customer to return to the partner's website after shopping for travel, where this model enhances the partner's brand.

Another difference is that with this model, the distributor may also choose to allow the distribution partner some control over what products are offered to consumers (e.g., excluding a specific airline, or including a product with a negotiated rate specific to the partner). In this model, the distributor shares revenues from travel product purchases with the partner. Almost any type of business can get this additional revenue as a distribution partner, with essentially no cost or effort to the partner. Examples of businesses that can be distribution partners include providers of travel products (e.g., airlines, hotels, car rental companies, cruise lines, conferences and conventions, media networks, not-for-profits, network marketing, educational and student organizations, entertainment events, tourism/destination sites, retailers, corporations offering employee online booking, professional and affiliate associations, travel agents, independent operators, etc.).

Yet another point of entry to online travel distributor server 110′ is through an original equipment manufacturer (OEM) portal 280 into distributor website 210. OEM-branded portal 280 allows a consumer to submit a travel product search request which automatically goes to distributor website 210. Search and distribution logic 150 handles the consumer-direct search request for a travel product in the manner described earlier in connection with FIG. 1, producing a result, which is provided back to OEM-branded portal 280. (To simplify the diagram, a single arrow 290 represents the consumer request and the corresponding result.)

Examples of a device hosting OEM-branded portal 280 include laptop computers, personal digital assistants (PDAs), media players, cell phones, etc. As another example of a device hosting OEM-branded portal 280, a Global Positioning System (GPS) device can integrate travel search with geographic data. Such integration might allow a consumer who is driving around a city to use his GPS unit to find nearby hotels, obtain information about each, and make a reservation at one. Under this OEM-distributor business model, the distributor shares the revenue of travel purchases made through OEM-branded portal 280.

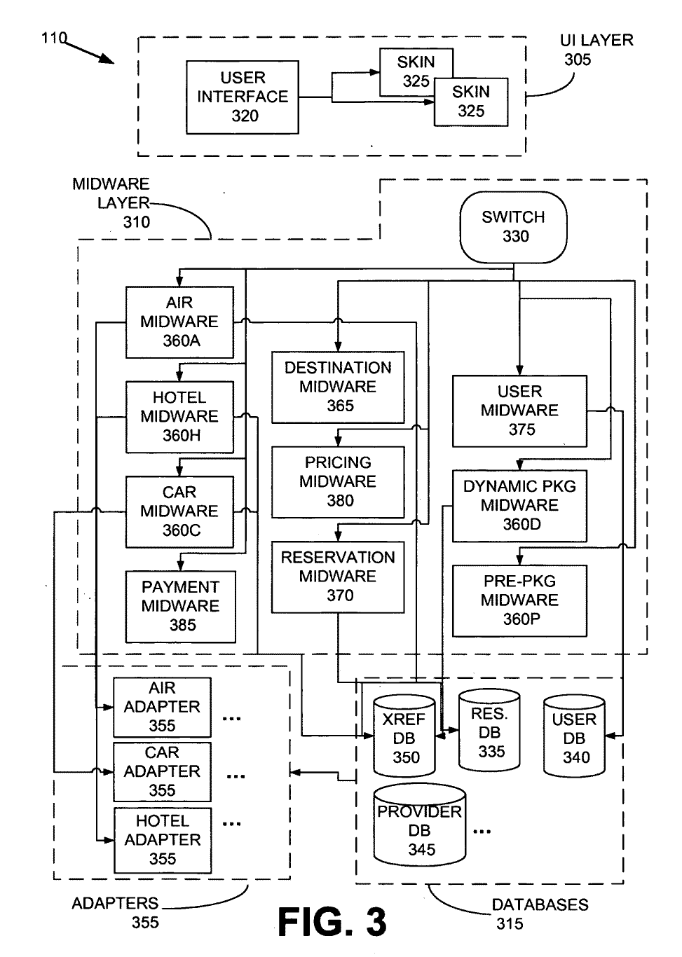

FIG. 3 is a block diagram of selected components of online travel distributor server 110 from FIG. 1, according to an embodiment of the present invention. Online travel distributor server 110 can be viewed as having three layers or tiers: a user interface layer 305; a middleware layer 310; and a database layer 315. In some embodiments, components within these layers are deployed as web services. In other embodiments, components are deployed as dynamic link libraries (DLLs). Other forms of packaging components are also contemplated.

User interface layer 305 is responsible for presenting data to customers and for customer interaction with customers to support the shopping process. The customer interaction is provided by user interface component 320, while customization components 325, commonly known as “skins”, tailor the user interface for particular customers. A skin 325 can be used, for example, to make the user interface provided by online travel distributor server 110 to look similar to a distribution partner's website.

Middleware layer 310 manipulates data coming from travel product provider systems 120 and from travel consumer clients 130 (FIG. 1), and prepares data to be shown on web pages. Middleware layer 310 is also responsible for: making decisions on what travel product provider systems 120 to send requests to; mapping results from different travel product provider systems 120 into a master product list; applying pricing rules to products and choosing what products to present to travel consumer clients 130; and implementing logic that supports shopping experience, for example, price and availability searches, product details, and reservation and cancellation requests.

User interface layer 305 does not directly access components in middleware layer 310. Instead, a switch component 330 provides a single entry point for user interface layer 305, redirecting requests from user interface layer 305 to the desired middleware component. User interface layer 305 and switch 330 communicate through one or more unified datasets. In one embodiment, a request dataset provides commands processed by middleware components, and inventory datasets are used to pass product details between user interlace layer 305 and middleware components. In some embodiments, middleware components are stateless, leaving the caller with the responsibility of providing all data needed for a request. Specific middleware components will be described in more detail below.

Database layer 315 includes: a reservations database 335; a user settings database 340; a provider database 345 containing original (unconverted) data; and a cross-reference database 350) containing mappings between provider products and master products, and mappings between products and destinations. Specific databases will be described in more detail below.

As described earlier, online travel distributor server 110 interoperates with travel products from a variety of providers, where different providers may have different types of travel product provider systems 120. Middleware layer 310 includes has an adapter 355 for each of these different provider systems 120. A particular adapter 355 is responsible for hiding provider specifics, by providing a unified set of functions to be used by middleware layer 310 (e.g., a common pattern), and converting travel data between a provider-specific format and a common format.

Specific middleware components will now be described in further detail. Each type of travel product is supported by a product middleware component 360. The embodiment shown in FIG. 3 includes air middleware 360A, hotel middleware 360H, car middleware 360C, pre-package middleware 360P, and dynamic package middleware 360D. Each product type component 360 has knowledge that is specific to the product type, but not specific to a provider. For example, one embodiment of air middleware 360A knows that air travel requires an originating airport, a destination airport, and a date/time, but does not know provider-specific details, such as Washington National Airport being referred to by code “321” by one airline and code “WNA” by another airline.

Pre-package middleware 360P handles bundles of travel products, sold only as a combination for a pre-defined price. Pre-packages are also known as “vacation packages”. Dynamic package middleware 360D handles bundles of products that are associated with a single price. Dynamic package middleware 360D is responsible for the bundling and the pricing so that individual product components (e.g., air, hotel, car) are unaware of the packaging. Dynamic package middleware 360D combines results provided by other product middleware.

Some embodiments of dynamic package middleware 360D take into account any differences in travel dates between products. For example, a flight arriving the same day as departure would be combined with a hotel for that day, while an overnight flight arriving the next day would not need a hotel for the night of departure. Dynamic package middleware 360D also decides what types of products, and that sub-types of products, to combine. For example, one embodiment combines a five-star hotel with a luxury car. Some embodiments of dynamic package middleware 360D apply different pricing rules than those applied by the constituent products, and can process payment for all products in a single transaction.

Dynamic package middleware 360D makes reservations in a specific order, based on the cancellation policy associated with the products. A typical order might be flight, car, and hotel, since flights can be cancelled with no penalty as long as ticket has not been issued, cars have a 24-hour no-charge cancellation, and hotels have widely varying policies. A rollback is available after every segment reservation, so that one segment fails then all segments reserved so far are cancelled.

Individual travel products have a notion of destination: a hotel is located at a particular destination; a rental car is picked up at a destination and dropped off at a destination; travelers are flying out of a particular destination and arriving at a particular destination. Thus, online travel distributor server 110 organizes travel products around destinations. When a product middleware component receives a search request, that component uses the services of destination middleware 365 to resolve a customer-supplied destination string into a destination that is known to online travel distributor server 110.

One embodiment of destination middleware 365 organizes destinations according to a hierarchy:
World
   Country
      State
         City

The number of levels in the hierarchy is not restricted, since there is no special meaning of what that level might stand for. This approach allows destinations to be described to any precision.

When provided a destination string by a product middleware component, destination middleware 365 attempts to find an item in the destination hierarchy that corresponds to the specified string. As one example, an input string of “Las Vegas, Nev.” results in finding the node “World->United States->NV->Las Vegas”. Destination middleware 365 uses conventional techniques to complete strings and/or to take misspellings into account. If it is impossible to find a single destination, then a list of destinations is returned. The customer then chooses a single destiantion from that list. Based on the single selected destination a list of products will be loaded from one of the following tables: destinationAir, destinationCarLocations, destinationProperties. These products are the target list of products for availability requests.

Reservation middleware 370 accesses reservations database 335 upon reservation requests from product middleware components. User management middleware 375 encapsulates accessing and managing user-related information. Pricing middleware 380 is used by product middleware components 360 to apply pricing rules to products, thus generating a price for a particular product. Some embodiments of pricing middleware 380 support pricing rules for each distribution partners. This set of rules can be specified for particular market and product provider.

Rules used by one embodiment include a set of cost ranges, which allows a different pricing strategy for each range. One embodiment of pricing middleware 380 supports net products, where the distributor receives cost from providers and can then mark up the price, and commissionable products, where prices are defined by provider, so the distributor is allowed no mark-up. Some embodiments with net products include “cost plus” rules, which allow the mark-up to be a fixed amount or based on product cost. Some embodiments of pricing middleware 380 include “price minus” rules. A “price minus” rule marks down the price of a commissionable product, and calculates margin for net products so as not to be more expensive than this given price.

Payment middleware 385 examines products selected by a user for purchase, and returns possible payment options to the corresponding product middleware component. In some embodiments, particular payment options (e.g., credit card, PayPal®, debit, wire transfer, etc.) are driven from a database and a product inventory dataset. In these embodiments, the payment database defines an overall set of options that can be presented on the travel consumer's search. Options from product inventory are used to reduce available options, if a particular product does not support everything that the provider supports. In some embodiments, payment middleware 385 also disburses payments to the travel product provider.

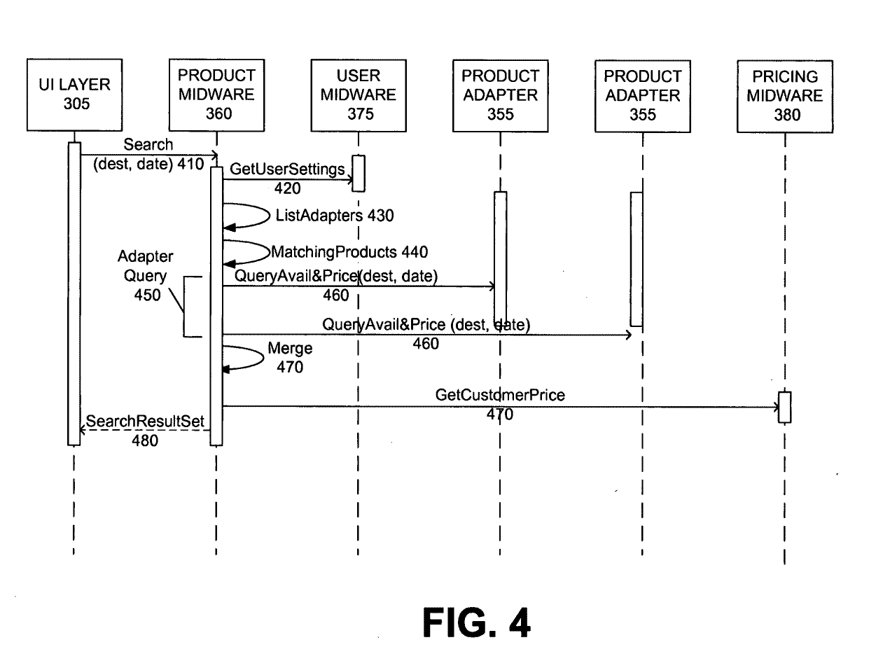

Having described the overall architecture of online travel distributor server 110 interactions between components will now be described. The process of searching or shopping for travel products will now be described in connection with the messaging diagram of FIG. 4. User interface layer 305 requests a search 410, providing parameters such as destination and date. Search request 410 is processed by the appropriate product middleware 360. (To simplify the diagram, interactions with switch 330 are not shown.) Product middleware 360 calls user management middleware 375 to retrieve user-specific settings 420. In the example embodiment of FIG. 4, these settings include a list of providers allowed for this user. Product middleware 360 itself supports a particular set of providers/adapters, which may not include all providers allowed for the user. Thus, product middleware 360 determines (430) which adapters 355 receive search requests by intersecting user-allowed adapters and supported adapters. Based on search parameters, product middleware 360 determines a list of matching provider products (440), and sends (450) price-and-availability queries (460) to the adapters 355A,355B for those products. When price-and-availability results are received, product middleware 360 merges (470) the results to produce a final list of matching travel products to be presented to the consumer. Product middleware 360 calls pricing middleware 380 to obtain the price (480) of each product. Finally, the set of search results 490, containing this final list of matching products, is returned to user interface layer 305.

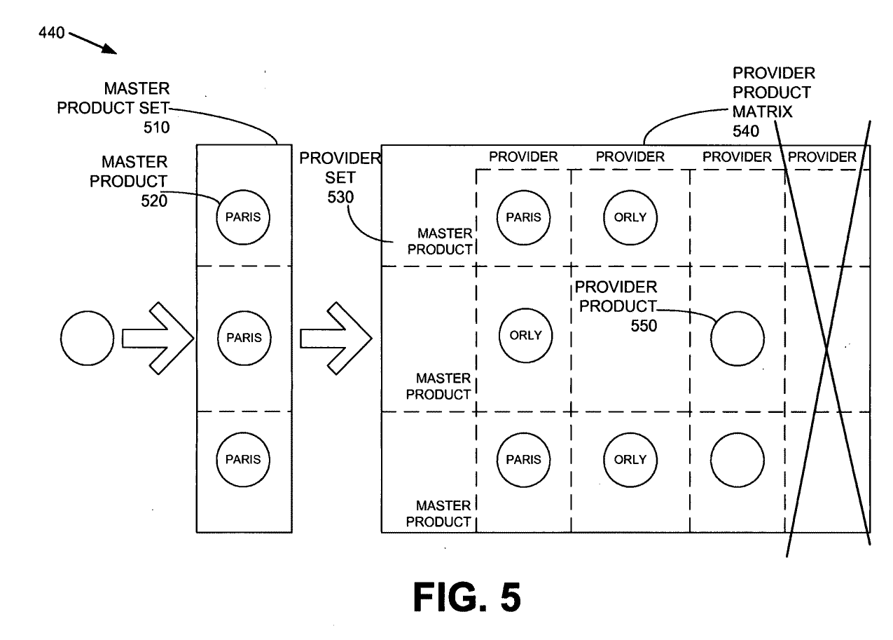

Various processes performed by product middleware 360 will now be described. FIG. 5 is a block diagram illustrating the matching process 440 from FIG. 4. Based on the destination search parameter, product middleware 360 queries provider database 345 to obtain a set 510 of master products 520 that each corresponds to the destination. The master product set 510 is a unique set of products, created from tables of provider products. For every master product, product middleware 360 creates a set 530 of those providers that include the master product. The combination of these two sets can be considered a provider product matrix 540, with a row for each master product in set 510, and having a column for each provider product 550 in set 530.

Every provider product 550 includes information identifying it to a travel product provider system 120 (FIG. 1). For example, in hotels, every hotel might be identified by its destination string, code, or a combination. The notion of destination may vary as well, where different providers identify the same destination in different ways. For example, one provider might use the string “Paris, FR”, and another provider uses the string “PAR”, and yet another provider uses code 123. The identifying information shown in FIG. 5 as text inside the circle representing a provider product 550.

The example provider product matrix 540 in FIG. 5 is interpreted as follows. Three master products 520 were found that match the search criteria. These three master products are found in set 510, and are all identified as “Paris”. A total of three providers offer the master products in set 510 as follows: Provider 1 offers master products 1, 2, and 3; Provider 2 offers master products 1 and 3; and Provider 4 offers master products 2 and 3. In the example scenario of FIG. 5, provider database 345 includes products from four providers, but the fourth provider has no matching products. In FIG. 5, this is shown as an X through the fourth column, but this may be implemented as a matrix with three columns rather than an empty column.

FIG. 5 also shows that the first master product 520 is identified by Provider 1 as “Paris” but by Provider 2 as “Orly”. The second master product 520 is identified by Provider 1 as “Orly” and by Provider 3 as “123”. The third master product 520 is identified by Provider 1 as “Paris”, but Provider 2 as “Orly”, and by Provider 3 as “321”.

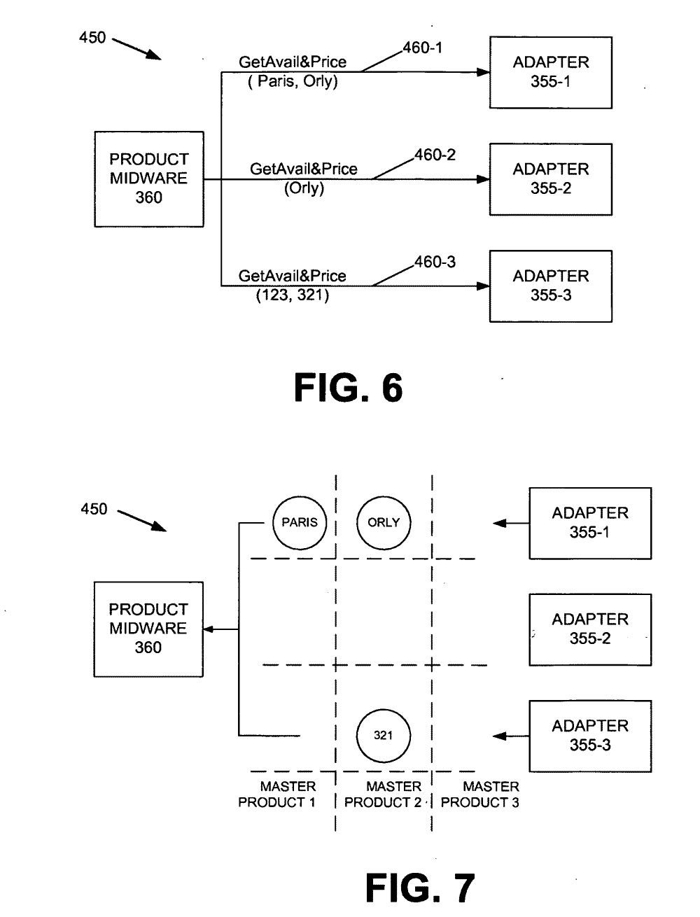

The block diagram of FIG. 6 illustrates the price and availability query process 450 of FIG. 4. Each provider in provider product matrix 540 is associated with an adapter 355. In this example scenario, there are three adapters: 355-1; 355-2; and 355-2. Product middleware 360 sends price-and-availability queries 460 to all three adapters. The query 460-1, sent to adapter 355-1 corresponding to Provider 1, is formed from the Provider 1 column of provider product matrix 540, so contains destinations “Paris” and “Orly”. Similarly, the query 460-2 is formed from the Provider 2 column of provider product matrix 540, so contains the single destination “Orly”. Finally, the query 460-3 is formed from the Provider 3 column of provider product matrix 540, so contains destinations “123” and “321”.

Adapters 355 have knowledge about how to communicate with a particular travel product provider system 120 (FIG. 1). In some adapter embodiments, a single query from product middleware 360 results in sending multiple requests to travel product provider system 120. For example, multiple provider requests may occur when providers do not support requests including multiple destinations, or when the number of requested products exceeds a maximum number allowed in the provider request.

The block diagram of FIG. 7 illustrates the merge process 470 of FIG. 4. Product middleware 360 waits for a period of time to receives results from the various travel product provider systems 120, then merges the results together. In the example of FIG. 7, adapter 355-1 returned two products back: one for master product 1, identified as “Paris”; and another for master product 2, identified as “Orly”. Adapter 355-3 has returned only one, for master product 2, identified as 321. Adapter 355-2 has no results. This scenario might occur when the product is not available at all, or when the product was not available in the specified window of travel time. Product middleware 360 then merges the results to update provider product matrix 540. If a particular provider had no results, then its corresponding column is removed. If a particular master product is not available anywhere, then its corresponding row is removed.

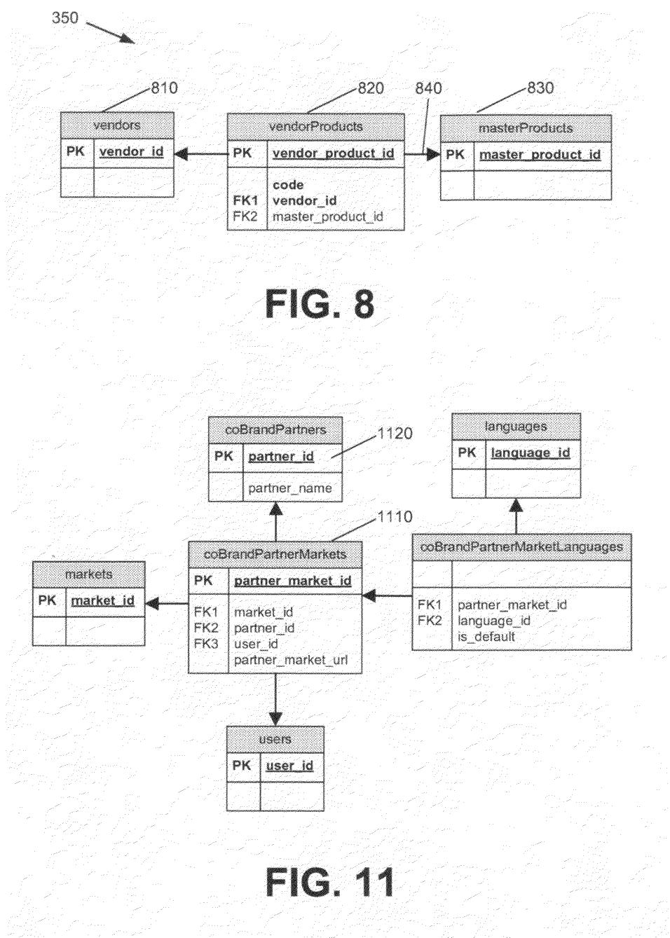

FIG. 8 illustrates an example schema for cross-reference database 350. Cross-reference database 350 defines a mapping between provider products and master products, and between products and destinations. This mapping allows a direct comparison of products from different providers. Without the mapping, a comparison between vendor products is an “apples to oranges” comparison. Mapping allows a comparison of “apples to apples” so that the system can offer the travel consumer a meaningful “best choice”, or a meaning ranking of top choices.

A Vendors table 810 has an entry for each travel product provider. Every provider has its own native list of products stored in a VendorProducts table 820. Entries in VendorProducts table 820 are sufficient enough to identify to a travel product provider system 120 both a product and a destination where the product is located. A MasterProducts table 830 is a unique set of products, which is created from entries in VendorProducts table 820. Multiple travel providers may feature the same products (e.g. same hotel chains, same rental companies). Therefore, cross-reference database 350 uses a link 840 between a record in VendorProducts table 820 and a record in MasterProducts table 830 to capture the fact that different provider products all represent the same master product.

Some embodiments of various product middleware components include an algorithm which takes advantage of these links 840 in cross-reference database 350, in order to filter out or exclude duplicates. When filtering out identical products, the algorithm takes price into account when choosing one product from a particular provider. When choosing from identical products, different pricing rules can be used to choose lowest price or best margin. Other selection factors can also be used. For example, the least-recently-chosen product provider might be chosen next, to improve the distributor-provider relationship. The end result of this filtering, in combination with provider-specific mapping described above, is that online travel distributor server 110 presents the travel consumer with a single best choice, or with a ranking of products met. Conventional travel price comparison websites (e.g. sites like kayak.com) do not perform this filtering.

Determining the cross-reference links—that is, which vendor products in VendorProducts table 820 map to the same master product in MasterProducts table 830—is a difficult problem. To appreciate the problem, consider hotels as an example product. The same hotel might have very different data in the name and address field: one provider lists as the “Marriott-Atlanta-Perimeter Center” while another lists as the “Perimeter Center Marriott”; one provider lists as “300 Ashford Parkway” while the other lists as “300 Ashford Pkwy”. The amount of data in these tables is quite large, for example, the number of hotels in the database might be on the order of 300,000 hotels, while the number of unique hotels is less than 100,000.

Automated matching techniques may not provide enough accuracy to identify matches within such widely differing data sets. Therefore, some embodiments of online travel distributor server 110 employs a combination of automated tools and human judgment is typically more efficient. For example, an automated tool can present an initial list of suspected identical products, and a human reviews the list to determine which products are actually identical. The human-confirmed matches can be fed back into the tool so that the tool can learn how to make a better match next time.

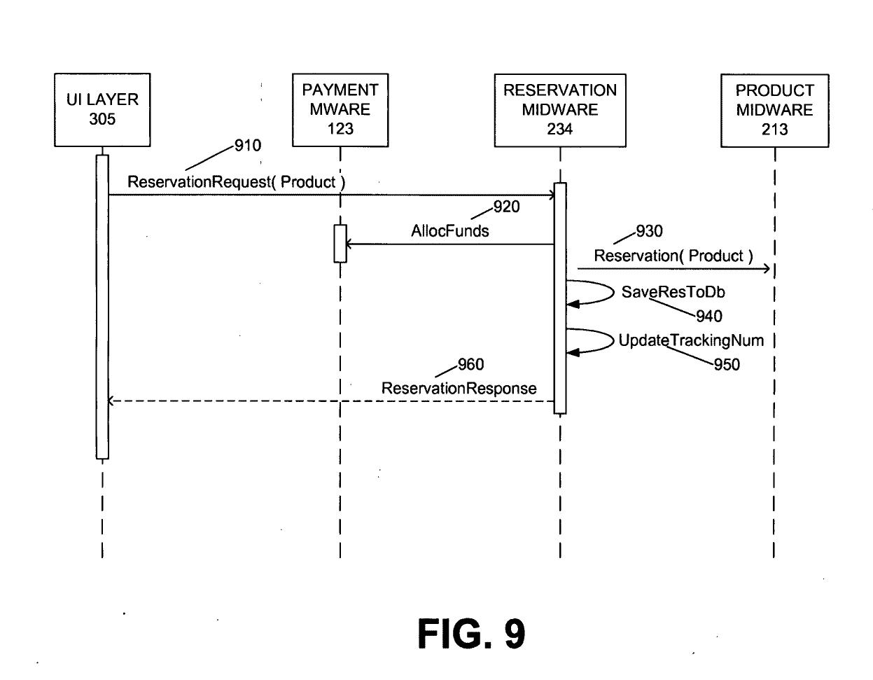

Continuing with the discussion of various components of online travel distributor server 110 shown in 3, FIG. 9 is a sequence diagram illustrating operation of an example embodiment of reservation middleware 370. In this embodment, a reservation is processed as a single transaction. Through user interface layer 305, reservation middleware 370 receives a reservation request 910. In response, reservation middleware 370 requests payment middleware 385 for allocation of funds 920. If necessary funds are successfully allocated, reservation middleware 370 sends a reservation request 930 to product middleware 360 to process the reservation request (via the underlying adapter, not shown). If the reservation response from product middleware 360 has no errors, reservation middleware 370 saves (940) the reservation to reservation database 335. Reservation middleware 370 updates (950) its reservation information with a tracking number that was generated by the write to reservation database 335. Reservation middleware 370 returns (960) the reservation, or error information (e.g., the transaction failed) to user interface layer 305. In some embodiments of online travel distributor server 110, the user sees a “receipt” page on success, or an error message on the “confirm” page on failure.

One embodiment of reservation database 335 includes travel segment-specific reservation data as well as common reservation data. Common data includes a a reservations table which contains general reservation information, for example, tracking number, name, description, total price and unique user identifier for the user who has created this reservation. Segment-specific data includes a table for each possible travel segment (e.g., airReservations, carReservations, hotelReservations) and a number of segment-specific tables (e.g., airReservationLegs, airReservationLegSegments and airReservationPassengers for Air segment). The air/car/hotel/Reservation tables have a set of common fields related to the common reservation data.

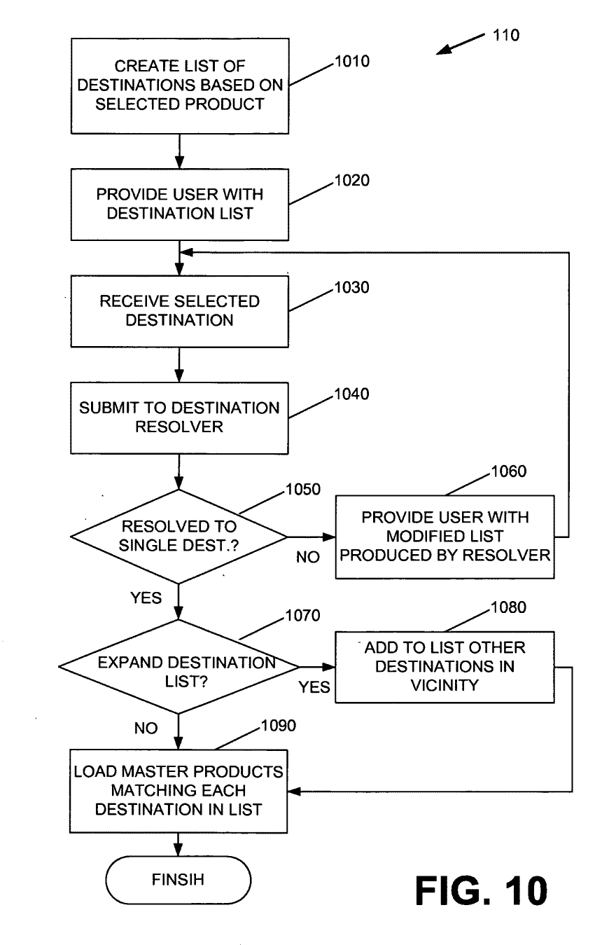

Moving on to another component of online travel distributor server 110 shown in 3, FIG. 10 is a flow chart showing operation of an example embodiment of destination middleware 365. Beginning with block 1010, destination middleware 365 creates a list of destinations, based on the travel product selected by the user. At block 1020, the destination list is presented to the travel consumer, and the user selection of one of the destinations in the list is received at block 1030. The selected destination is provided to a destination resolver at block 1040. Block 1050 determines whether the destination resolver was able to resolve to a single destination. (For example, “London” may not be fully resolved, but instead narrowed to a list of two, “London, UK” and “London, Ohio, US”). If full resolution to a single destination was not achieved, then at block 1060 the narrowed list as modified by the resolver is presented to the user, and processing returns to block 1030 to wait the user's next selection. If a single destination was resolved, processing continues at block 1070, where destination middleware 365 determines whether or not the destination is expanded to include other destinations. If Yes, nearby destinations are added to the destination list at block 1080. For example, one embodiment of air middleware 360A may resolve “NYC” to “New York City”, but then expand “New York City” so that nearby airports such as Newark are also presented to the user. Whether or not the destination list was expanded, processing finishes with block 1090, where a list of master products matching each destination in the list is loaded.

As described earlier in connection with the user interface layer 305 of FIG. 3, online travel distributor server 110 supports requests from multiple distribution partners, each of which can look and behave differently. For example, travel.espn.com could look and behave differently from travel.google.com. Therefore, when a user request is received, online travel distributor server 110 identifies the appropriate settings to use when fulfilling the request. The process of using portions of an incoming request user interface layer 305 to identify various user settings will now be discussed in connection with FIG. 11, which illustrates an example schema for user settings database 340.

A user request is directed to a specific URL hosted by online travel distributor server 110. The host name in the URL is used to find a partner and market corresponding to the URL. The URL also specifies a distribution partner and a market, found in cobrandPartnerMarkets table 1110. The username portion of the URL is used to log the user into online travel distributor server 110, and to load settings associated with that user. A Partner_id 1120 is used to identify the partner name, from which is derived the name of the directory or folder containing the partner-specific skin 325 (see FIG. 3).

If the URL includes a language parameter (e.g., specified as lang=<ISO language code>), then the language parameter is checked against what was defined for the partner in a cobrandPartnerLanguages table 1130. This allows every partner to have a unique list of languages for every market. If a language entry is found, web pages and/or generated content are presented in that language. Otherwise, a default language for the partner should be used (e.g., the one with the is_default flag specified in the cobrandPartnerLanguages table 1130).

The system user is also found in cobrandPartnerMarkets table 1110. User-specific settings are loaded, based on the identified system user. User management middleware 375 is responsible for managing user settings. In one embodiment of user management middleware 375, users are organized in a tree-like structure. Thus, every user except the root has exactly one parent user The top-level user, or root, is granted with all rights/permissions. The permissions of a user's descendants are a subset of the parent user's permissions. Thus, permissions of a descendant are defined by applying restrictions to the permissions of the parent user. In one embodiment, permissions of newly created user are calculated once at the time of creation and saved to user settings database 340, rather than calculating effective permissions by traversing over all the ancestors.

User settings are stored separately for each application. Applications settings is a typed DataSet of arbitrary structure. The dataset is saved into a database in XML representation. User management middleware 375 is not required to be aware of the settings structure.

In one embodiment, a user is explicitly managed only by his direct parent, and a user can be implicitly managed by his indirect ancestor in the following cases. First, when the user's ancestor is set to inactive. In that case, all descendants are set to inactive state as well. Second, when the settings of his parent are reduced. To make sure all descendants' permissions are not wider, user management middleware 375 examines all descendants, and removes corresponding settings. All the updates (including update of the parent) are considered as an atomic operation so should be properly transactioned.

In addition to the search and distribution features described above, some embodiments of online travel distributor server 110 also support online distribution of travel products offered by inbound operators. An agreement between the online travel distributor and each inbound operator specifies how revenue will be allocated between the two parties. The online travel distributor provides a product content management system (CMS) which an inbound operator, located anywhere in the world, can access. The distributor's system allows an inbound operator to enter his product data through a series of web pages and forms. In contrast, a conventional travel website typically requires an inbound operator to provide the travel website with an extensible markup language (XML) feed from the inbound operator's own product database, which can be prohibitively expensive for a small operator.

The CMS data includes product descriptions (e.g., text, images, video, audio), rates, commission, availability, cancellation policy, and agreements terms/conditions. Once the data is entered, the inbound operator's products are available for purchase by consumers anywhere in the world, through online travel distributor server 110, and the products are discoverable by the consumer through the search capabilities of online travel distributor server 110 (described above). Online travel distributor server 110 tracks real-time availability of the inbound operator's products, makes reservations (“bookings”), takes payment from consumers, and distributes revenue to the inbound operator.

The inbound operator also has several views of his data via the CMS, including new bookings, new cancellations, arrival lists and turnover. The inbound operator can also easily and cheaply add booking to his own website, using the distributor's booking engine. These services can be provided to the inbound operator at little or no cost, since the distributor makes money on the product sale. This model gives the inbound operator incentive to offer all his travel products through the distributor, which makes more money for the inbound operator and for the distributor.

Inbound operator products vary greatly, and the data scheme used by the distributor's CMS is generic enough to support almost any type of product. Examples include, but are not limited to, a carriage ride and picnic in Central Park; a 3-day tour of Berlin; a camel ride in Dubai; and a rock-climbing trip in the Andes. Inbound operator products are mapped into one of a set of product types supported by online travel distributor server 110. One embodiment of online travel distributor server 110 supports this set of product types: restaurant; rental (e.g., car, horse, bicycle, fishing boat); package, which is accommodation plus another travel product (e.g., a week in Majorca, 3 days in Maui; tour, which is accommodations in multiple cities (e.g., art tour of France, castle tour of Bavaria); activity, which is one day or less, no overnight (e.g., scuba diving fishing); ground transport (e.g., bus, rail, limousine, van, boat); accommodation (e.g., hotel, villa, apartment, campsite).

Each product type supported by online travel distributor server 110 includes a set of attributes. Some attributes are common to all types. Examples of such common types include default currency, cancellation policy, commission, text description, images, operating hours, allocation, and price. Other attributes are specific to a product type.

Various types of pricing strategies are supported by online travel distributor server 110. As one example, product prices can be net of a specified commission, or subject to a specified commission. As another example, taxes can be included, excluded, or not applicable. Prices typically differ according to time of year, number of persons, etc., so the CMS takes this into account. For each different price offered by the inbound operator for a particular product, the inbound operator enters an operating time (date range, operating days, operating hours), a number of persons, and the price. Pricing can be specified as per-person, per-hour, etc. whatever makes sense for the particular product type.

One embodiment of online travel distributor server 110 supports these attributes specific to the rental product type include: rental period, pick up and drop off locations, and included services. One embodiment of online travel distributor server 110 supports these attributes specific to the ground transportation product type include a transfer-from location and transfer-to location, a distance, a duration, a vehicle type, and included services. One embodiment of online travel distributor server 110 supports these attributes specific to the activity product type include: a duration, supported language(s), and included services. One embodiment of online travel distributor server 110 supports these attributes specific to the tour product type include: a duration, language(s), a description of each day, which meals are provided on each day, and a list of services included with the activity. One embodiment of online travel distributor server 110 supports these attributes specific to the package product type include: a duration, a list of included services, a list of included products, a description of each day, and which'meals are provided on each day. One embodiment of online travel distributor server 110 supports these attributes specific to the accommodation product type include: include: nearest airport (domestic, international); rating; room types; facilities for each room type; hotel facilities; allocation and free sale (described by quantity of rooms offered during specific periods); close out dates; free night policy; minimum stay; and discount policy.

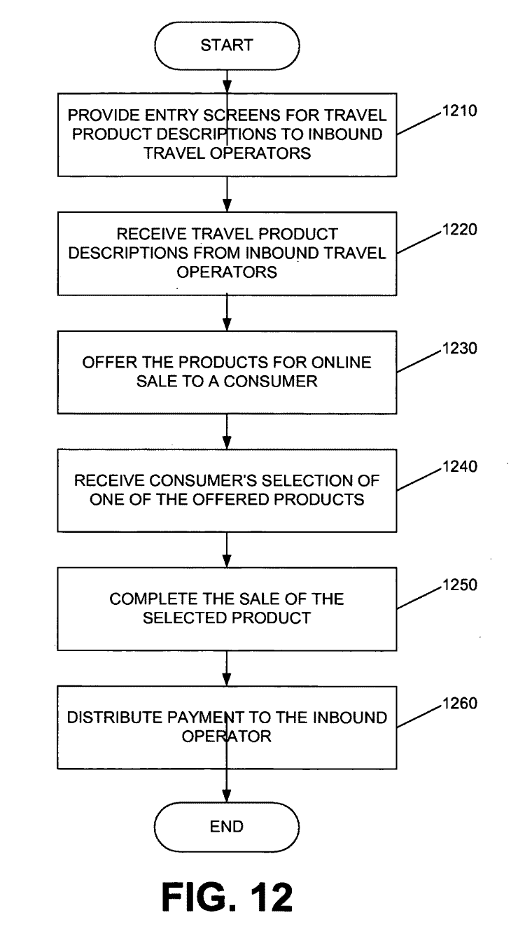

FIG. 12 is a flowchart of a process used by one embodiment of online travel distributor server 110 to distribute inbound operator products. At block 1210, inbound travel operators are provided with entry screens for travel product descriptions. Next, at block 1220, travel product descriptions are received from inbound travel operators. Processing continues at block 1230, where the products are offered for online sale to a consumer. At block 1240, the consumer's selection of one of the offered products is received. Next, at block 1250, the sale of the selected product is completed, which may include receiving payment from the consumer. Finally, at block 1260, payment is distributed to the inbound operator associated with the purchased product, according to the terms of the agreement between the online travel distributor and the inbound operator.

In addition to the search and distribution features described above, some embodiments of online travel distributor server 110 also support travel multi-level marketing, which automates financial disbursements for an unrestricted number of levels. A customer buys a travel product through a private label website, or through an affiliate website. As described elsewhere in this disclosure, a website of a distribution partner, such as a private label or an affiliate website, acts as a front-end to online travel distributor server 110. When the customer buys a product, the private label or affiliate system appears to online travel distributor server 110 as a “user” associated with the transaction. Online travel distributor server 110 supports a hierarchical arrangement of user relationships by storing user relationships in a tree, with the root representing the distributor. By treating the user as a leaf and traversing up to the root, online travel distributor server 110 can capture each intermediate user associated with the leaf, can calculate each intermediate's share of the revenue, and automatically disburse payment to the intermediate and leaf users.

Representing users in a hierarchical structure also allows online travel distributor server 110 to support various types of organizational structures used by distribution partners. As one example, a travel agency that has a single office, or does not want users separated by offices would have a flat hierarchy (e.g. Root->Travel Agency->user1, user2, user3, etc.) In this case, every user of the system works under a personal login identifier. If the same agency does not want to impersonate users, but instead wants agents coming to the site and working within pre-defined settings, a single user is used (e.g., Root->Travel Agency). All agents work under the user “Travel Agency”. As another example, a corporation with multiple offices can use the structure: Root->Company->US Office->user1, user2; Root->Company->German Office->user1, user2. This flexible hierarchy allows separate settings for the various offices.

This structure also allows providers and affiliates to create sublevel providers as sub users. Sublevel providers can use their access to the provider's private (“back office”) system to create and input travel products into online travel distribution system 100. The sublevel provider may allow these custom products to be sold only on the sublevel provider's own website, or to be sold on any affiliate web site. The affiliate or supplier who has created the sublevel provider then receives the negotiated revenue percentage when these products are sold through an affiliates web site.

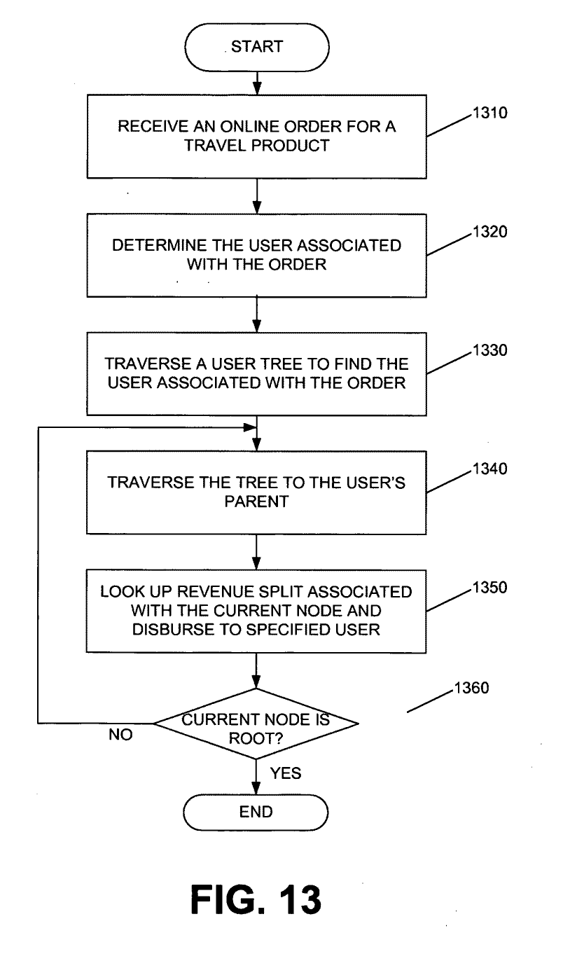

FIG. 13 is a flow chart of a process used by one embodiment of online travel distributor server 110 to track payments distributed among travel affiliates. At block 1310, an online order for a travel product is received. Next, at block 1320, the user associated with the order is determined. Processing continues at block 1330, where a user tree is traversed to find the user associated with the order. At block 1340, the tree is traversed to that user's parent, so that the parent becomes the current node. Next, at block 1350, the revenue split associated with the current node is determined, and disbursed to the user specified by the current node. Next, at block 1360, it is determined whether the current node is the root. If Yes, the process is completed. If No, processing continues at block 1340, where the process is repeated for the parent of the current node. f

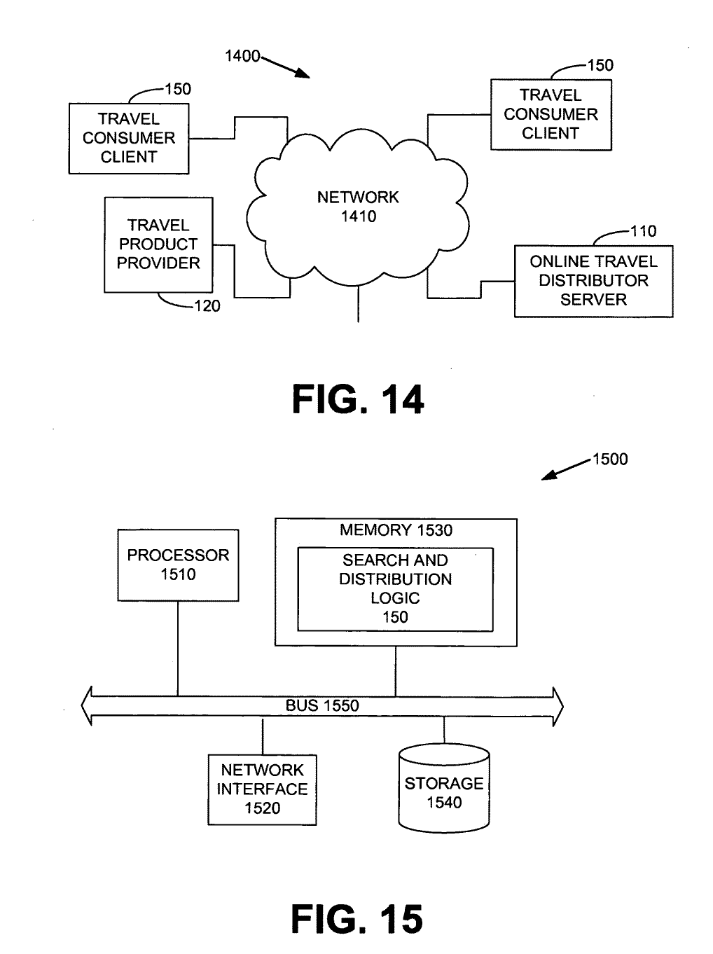

FIG. 14 is a block diagram of network environment 1400 for the online travel distribution system 100 of FIG. 1. Online travel distributor server 110, travel product provider systems 120, and one or more travel consumer clients 130 communicate with each other via network 1410. Network 1410 includes, for example, the Internet, intranets, wide area networks (WANs), local area networks, wireless networks, or other suitable networks, etc., or any combination of two or more such networks.

In one embodiment, online travel distributor server 110 is implemented by a web server which accept hypertext transport protocol (HTTP) requests, and in response serves HTTP responses along with optional data contents. These contents may include web pages such as hypertext markup language (HTML) documents and linked objects (e.g., images, sounds, videos, etc.). In some embodiment, one or more of travel consumer clients 130 is implemented by a web browser, which sends HTTP requests to a web server, and displays to the user the contents returned by the web server. Some embodiments of online travel distributor server 110 and online travel distribution system 100 may communicate using technologies such as web services and extensible markup language (XML).

FIG. 15 is a hardware block diagram of a general-purpose computer 1500 which can be used to implement various embodiments of online travel distributor server 110. Computer 1500 contains a number of components that are well known in the computer arts, including a processor 1510, a network interface 1520, memory 1530, and storage device 1540. These components are coupled via a bus 1550. Memory 1530 contains search and distribution logic 150 which comprises instructions executed by the processor 1510 to implement the processes depicted in the diagrams of FIGS. 1-12. Omitted from FIG. 15 are a number of conventional components that are unnecessary to explain the operation of computer 1500.

The systems and methods disclosed herein can be implemented in software, hardware, or a combination thereof. In some embodiments, the device, system, and/or method is implemented in software that is stored in a memory and that is executed by a suitable microprocessor, network processor, or micro controller situated in a computing device. In other embodiments, the device, system and/or method is implemented in hardware, including, but not limited to, a programmable logic device (PLD), programmable gate array (PGA), field programmable gate array (FPGA), an application-specific integrated circuit (ASIC), a system on chip (SoC), and a system in package (SiP).

The systems and methods disclosed herein can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) an optical fiber and a portable compact disk read-only memory (CD-ROM).

The software components illustrated herein are abstractions chosen to illustrate how functionality is partitioned among components in some embodiments of a system and method for anti-aliasing a procedural texture. Other divisions of functionality are also possible, and these other possibilities are intended to be within the scope of this disclosure. Furthermore, to the extent that software components are described in terms of specific data structures (e.g., arrays, lists, flags, pointers, collections, etc.), other data structures providing similar functionality can be used instead. As just one example, a particular implementation might use a linked list instead of an array.

Software components are described herein in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Software components referred to herein include executable code that is packaged, for example, as a standalone executable file, a library, a shared library, a loadable module, a driver, or an assembly, as well as interpreted code that is packaged, for example, as a class. In general, the components used by the systems and methods for anti-aliasing a procedural texture are described herein in terms of code and data, rather than with reference to a particular hardware device executing that code. Furthermore, the systems and methods can be implemented in any programming language, and executed on any hardware platform.

Process descriptions or blocks in flowcharts represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved.

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

1. A computer-implemented method of distributing online travel products performed by a travel distributor, comprising:
receiving a search request from a customer describing a travel product of interest to the customer;
submitting the search request to each of a plurality of travel product providers, each of the travel product providers having an agreement specifying a revenue split for each travel product offered by the provider to the distributor;
receiving a search result including at least a portion of the plurality of travel products as a result of the search request; and
selecting one of products in the search result as a best choice for the customer; and
selling the selected travel product online to the customer.

2. The method of claim 1, further comprising:
creating a search request based on the product description received from the customer;
mapping the search request to a plurality of search requests, each of the mapped search requests in a format understood by one of the plurality of providers;
submitting each of the mapped search requests to the corresponding provider;
receiving a result of the plurality of travel products in response to the mapped search requests; and
mapping each the products in the result to a common format; and
selecting one of products in the result as the best choice for the customer.

3. The method of claim 2, wherein the product description includes a destination, the method further comprising:
creating a list of master products which include the destination and a list of providers offering each master product, to produce a product matrix;
for each provider in the list, mapping the search request to a provider-specific search request using a format understood by that provider; and
submitting, to each of provider in the list, the mapped search request for that provider.

4. The method of claim 3, further comprising:
determining whether one provider product in the result represents the same master product as another provider product in the results set; and
responsive to the determination, removing from the matrix one of the provider products representing the same master product.

5. The method of claim 3, further comprising:
for each product in the result, filling in the products in the matrix with price information from the search results;
applying a pricing rule associated with each product in the matrix to the price information of that product to produce a final price for that product; and
selecting one or more of the products in the matrix as the best choice for the customer based on the final price of each product.

6. A method of searching for online travel products, comprising:
receiving a first consumer travel search request at a first website operated by a distributor, the first consumer travel search request including a first travel product description;
producing a first web page including a first set of search results in response to the first consumer travel search request;
receiving a second consumer travel search request at the first website, the second consumer travel search request including a second travel product description which is substantially equivalent to the first travel product description, the second consumer travel search request being received after redirection from a second website operated by a distribution partner of the distributor; and
sending to the second website a second web page including substantially a second set of search results which is substantially the same as the first set of search results.

7. The method of claim 6, wherein the second web page has a visual appearance which is substantially identical to a web page on the second website.

8. The method of claim 6, wherein the redirection is transparent to a consumer using the second website.

9. The method of claim 6, wherein the redirection is effected by the first website in a manner which is transparent to a consumer using the second website.

10. The method of claim 6, wherein the redirection is a result of user selection of a hyperlink on the second website.

11. The method of claim 6, further comprising:
performing search engine optimization on a plurality of web pages on the first website in order to positively affect a search by a search engine for keywords on the plurality of web pages.

12. The method of claim 6, further comprising:
performing search engine optimization on a plurality of web pages on the first website in order to positively affect a search by a search engine for keywords on the plurality of web pages; and
receiving, by a search engine website, a third consumer travel search request;
searching, by the search engine website, an index of web pages including the optimized pages on the first website; and
returning, by the search engine website, one of the optimized pages as a result of the third consumer travel search request.

13. A method of distributing travel products online, the method performed by a travel product distributor, the method comprising:
allowing each of a plurality of inbound travel operators to upload a description of a travel product offered by that travel operator, the description specifying a revenue split for the travel product;
offering for online sale to consumers the plurality of travel products; and
selling one of the plurality of travel products as selected by a consumer.

14. The method of claim 13, further comprising:
collecting payment for the sale from the customer; and
distributing the payment according to the revenue split associated with the product.

15. The method of claim 13, wherein the service is provided at no charge to the travel operator.

16. The method of claim 13, wherein the selling further comprises:
making a reservation for the selected travel product.

17. The method of claim 13, further comprising:
providing a booking service to the operator through which the operator can make reservations for the travel products offered by the operator and sold online by the distributor.

18. The method of claim 13, further comprising:
providing a service to the operator through which the operator can view new bookings made by the distributor for the travel products offered by the operator.

19. The method of claim 13, further comprising:
providing a service to the operator through which the operator can view new cancellations of bookings made by the distributor for the travel products offered by the operator.

20. The method of claim 13, further comprising:
providing a service to the operator through which the operator can view arrival lists corresponding to bookings made by the distributor for the travel products offered by the operator.

21. The method of claim 13, further comprising:
allocating a portion of the profit to the payment to the online travel distributor according to the revenue split associated with the product; and
paying the provider of the product according to the revenue split associated with the product.

22-25. (canceled)
